(19) United States
(12) Patent Application Publication
(10) Pub. No.: US 2007/0237440 A1
(43) Pub. Date: Oct. 11, 2007

(54) Assembly structure of bearing unit for mounting rotary body to engine cover and assembly method therefor

(76) Inventor: Seung-Woo Lee, Seoul (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/646,289

(22) Filed: Dec. 26, 2006

(30) Foreign Application Priority Data
Apr. 7, 2006 (KR) 10-2006-0031951

(51) Int. Cl. F16C 43/00

(52) U.S. Cl. 384/537

(57) ABSTRACT

An assembly structure of a bearing unit for mounting a rotary body to an engine cover includes a fitting hole in the engine cover for mounting a housing of the bearing unit; a counter bore in the fitting hole, substantially coaxial with a rotating shaft of the bearing unit; and sealing means sealing the counter bore. An assembly method of a bearing unit for mounting a rotary body to an engine cover includes force-fitting a housing of the bearing unit into the engine cover; fitting a rotary body or a bracket of the rotary body over a rotating shaft of the bearing unit while the rotating shaft of the bearing unit is supported by a shaft jig through a counter bore; and sealing the counter bore.

### CROSS-REFERENCE TO RELATED APPLICATIONS

The present application is based on, and claims priority from, Korean Application Serial Number 10-2006-0031951, filed on Apr. 7, 2006, the disclosure of which is hereby incorporated by reference herein in its entirety.

### FIELD OF THE INVENTION

The present invention relates to assembly structures of bearing units for mounting rotary bodies to an engine cover and assembly methods therefor and, more particularly, to a technique for fitting a bearing unit having a rotating shaft into an engine cover.

### BACKGROUND OF THE INVENTION

In general, a bearing unit is mounted to a timing chain cover, and a bracket is fitted over a rotating shaft of the bearing unit. A cooling fan, pulley or the like may be coupled to the bracket.

To fit the bearing unit into the timing chain cover, a housing of the bearing unit is forcibly fitted into a fitting hole in the timing chain cover using a jig.

When the bearing unit is forcibly fitted into the fitting hole 6, a load is applied to the housing, but not to the rotating shaft of the bearing unit. As such, load is prevented from being undesirably applied between the housing and the rotating shaft of the bearing unit, thus protecting the bearing unit from damage.

A rotary body, or a bracket for supporting the rotary body, is provided on the rotating shaft of the bearing unit by a force-fitting method, so that rotation of the rotary body is supported by the rotating shaft. However, during the force-fitting process, because a fitting load is applied only to the rotating shaft, an excessive load is applied between the rotating shaft and the housing. As a result, the bearing unit may be damaged, for example, indentations may be formed in bearings provided in the bearing unit. Due to this, noise occurs when the rotary body rotates, and the durability of the bearing unit is deteriorated.

The above information disclosed in this Background section is only for enhancement of understanding of the background of the invention and therefore it may contain information that does not form the prior art that is already known in this country to a person of ordinary skill in the art.

### SUMMARY OF THE INVENTION

Embodiments of the present invention provide an assembly structure for a bearing unit for mounting a rotary body to an engine cover and an assembly method therefor, which prevent the bearing unit from being deformed or damaged while mounting a bearing unit having a rotating shaft to an engine cover, and a process of fitting a rotary body or a bracket for mounting the rotary body over the rotating shaft of the bearing unit mounted to the engine cover, thus reducing the amount of noise generated by the bearing unit when the rotary body rotates, and preventing the durability of the bearing unit from being reduced.

An assembly structure of a bearing unit for mounting a rotary body to an engine cover according to an embodiment of the present invention includes a fitting hole in the engine cover. A housing of the bearing unit is fitted into the fitting hole. A counter bore is formed in the fitting hole through the engine cover such that the counter bore is coaxial with a rotating shaft of the bearing unit. A sealing means seals the counter bore.

An assembly method of a bearing unit for mounting a rotary body to an engine cover according to an embodiment of the present invention includes force-fitting a housing of a bearing unit into an engine cover. The rotary body, or a bracket of the rotary body, is fitted over a rotating shaft of the bearing unit while the rotating shaft of the bearing unit is supported by a shaft jig through a counter bore. The counter bore is sealed with a sealing means.

### BRIEF DESCRIPTION OF THE DRAWINGS

For a better understanding of the nature and objects of the present invention, reference should be made to the following detailed description with the accompanying drawings, in which:

FIG. 1 is a view showing a timing chain cover, a bearing unit and a bracket according to an embodiment of the present invention;

FIG. 2 is a detailed view showing a fitting hole formed in the timing chain cover of FIG. 1;

FIG. 3 is a view illustrating a process of fitting the bearing unit into the timing chain cover of FIG. 1;

FIG. 4 is a view illustrating a process of fitting the bracket over the bearing unit of FIG. 1; and

FIG. 5 is a view showing the bracket fitted over a rotating shaft of the bearing unit, which is fitted into the timing chain cover of FIG. 1.

### DETAILED DESCRIPTION OF THE PREFERRED EMBODIMENTS

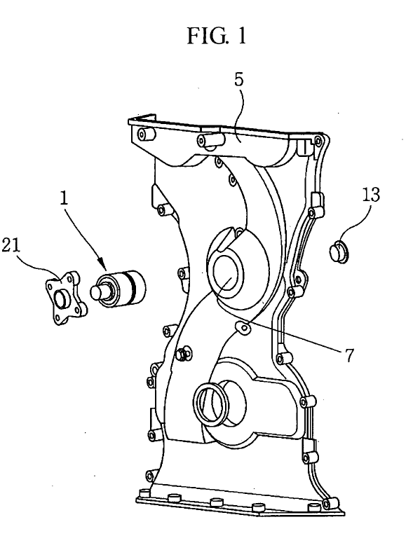

Referring to FIGS. 1 through 5, an assembly structure according to an exemplary embodiment of the present invention includes a fitting hole 7 formed in a timing chain cover 5, into which a housing 3 of a bearing unit 1 is fitted; a counter bore 9, which is formed in the fitting hole 7 through the-timing chain cover 5 such that the counter bore 9 is coaxial with a rotating shaft of the bearing unit 1; and a sealing means 11, which seals the counter bore 9.

In some embodiments, the sealing means 11 includes a plug bolt 13, which is screwed to the counter bore 9; and a gasket 15, which is interposed between the plug bolt 13 and the timing chain cover 5. An internal thread is formed on the counter bore 9 such that the plug bolt 13 is screwed to the counter bore 9. Furthermore, the counter bore 9 has a diameter similar to that of the rotating shaft of the bearing unit 1 for easy and removable insertion of a shaft jig J1 into the counter bore 9. The shaft jig J1 will be described in detail below.

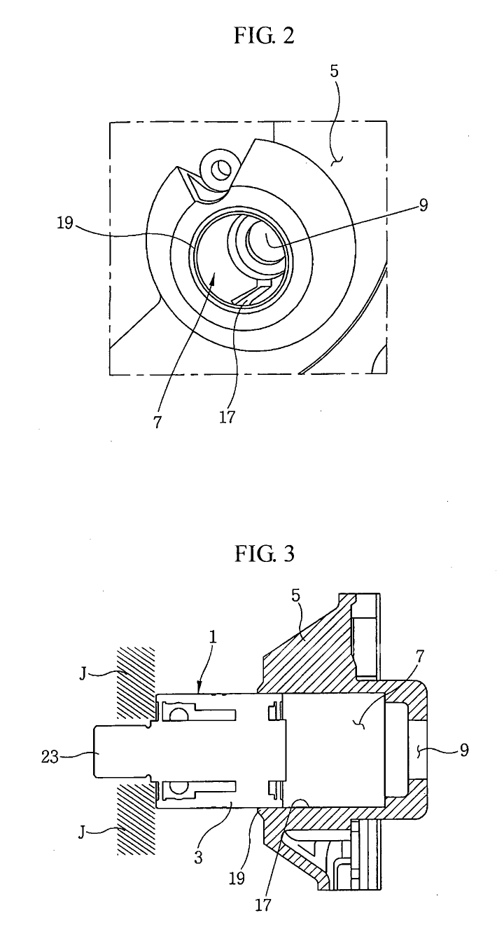

Referring to FIG. 2, a cooling groove 17, the shape of which is depressed from the circumferential inner surface of the fitting hole 7 to thus form a surface spaced apart from the housing 3 of the bearing unit 1, is longitudinally formed in the circumferential inner surface of the fitting hole 7 in the direction in which the housing 3 of the bearing unit 1 is fitted into the fitting hole 7.

A rotary body, such as a cooling fan (not shown), may be mounted to the rotating shaft of the bearing unit 1. The fan blows air toward the timing chain cover 5, drawing air into the cooling groove 17, thus cooling the bearing unit 1.

Furthermore, a support protrusion 19 protrudes from the front surface of the timing chain cover 5 around the entrance of the fitting hole 7. The support protrusion 19 is treated by caulking while surrounding the bearing unit 1, which is fitted into the fitting hole 7.

That is, after the bearing unit 1 has been fitted into the fitting hole 7, the support protrusion 19 is formed by roller-caulking. Then, the bearing unit 1 can reliably maintain its fitted state in the fitting hole 7 without being removed from the fitting hole 7.

Referring to FIG. 3, the housing 3 of the bearing unit 1 is force fit into the fitting hole 7 using a jig J.

The fitting process is conducted by pressing the housing 3 of the bearing unit 1, and the counter bore 9 is in an open state.

The support protrusion 19 is formed by roller-caulking such that the bearing unit 1 reliably maintains its fitted state in the fitting hole 7.

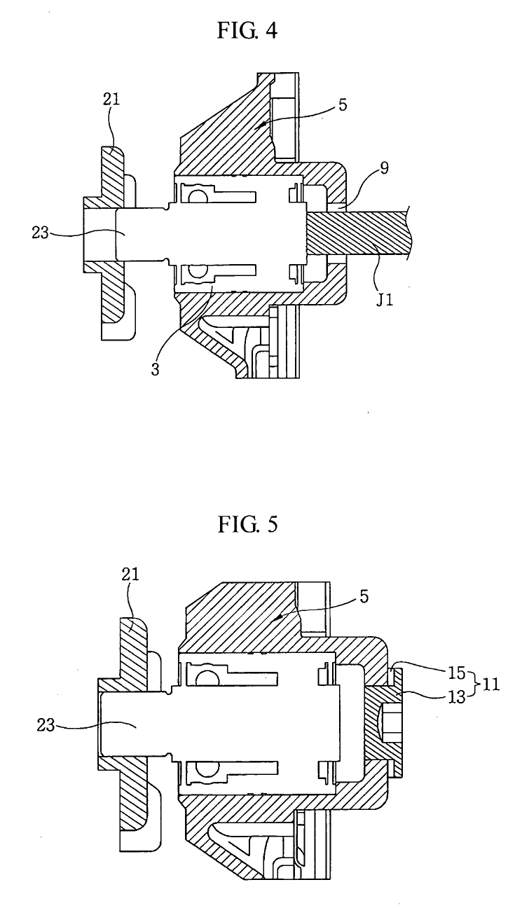

Thereafter, the rotating shaft of the bearing unit 1 is supported by the shaft jig J1 through the counter bore 9. In this state, as shown in FIG. 4, a rotary body, or a bracket 21 for the rotary body, is fitted over the rotating shaft 23 of the bearing unit 1.

At this time, the timing chain cover 5 is in an unrestricted, freely movable state. Therefore, even if a fitting load is applied to the rotary body or the bracket 21 of the rotary body, no relative load is applied between the rotating shaft 23 of the bearing unit 1 and the housing 3, thus preventing the bearing unit 1 from being deformed or damaged.

Here, for example, when it is desired to support a cooling fan on the bearing unit 1, the term “rotary body” means such a cooling fan. If the cooling fan is not directly fitted over the rotating shaft 23 of the bearing unit 1 but is fitted over the rotating shaft 23 using a bracket, the bracket 21 of the rotary body is the bracket used for mounting the cooling fan.

The counter bore 9 is sealed by the plug bolt 13 and the gasket 15, which are the sealing means 11 that prevents noise from escaping and prevents oil from leaking outside the timing chain cover 5.

As is apparent from the foregoing, in the present invention, the bearing unit is prevented from being deformed or damaged during a process of mounting a bearing unit having a rotating shaft to an engine cover and a process of fitting a rotary body or a bracket for mounting the rotary body over the rotating shaft of the bearing unit mounted to the engine cover, thus reducing noise generated by the bearing unit when the rotary body rotates, and preventing the durability of the bearing unit from being reduced.

What is claimed is:

1. An assembly structure of a bearing unit for mounting a rotary body to an engine cover, comprising:
a fitting hole in the engine cover for mounting a housing of the bearing unit;
a counter bore in the fitting hole, substantially coaxial with a rotating shaft of the bearing unit; and
sealing means sealing the counter bore.

2. The assembly structure as defined in claim 1, wherein the sealing means comprises:
a plug bolt screwed into the counter bore; and
a gasket between the plug bolt and the engine cover.

3. The assembly structure as defined in claim 1, further comprising a cooling groove at an inner surface of the fitting hole, depressed from the inner surface of the fitting hole to form a surface spaced apart from the housing of the bearing unit.

4. The assembly structure as defined in claim 1, further comprising a support protrusion protruding from a surface of the engine cover around an entrance of the fitting hole, the support protrusion being treated by caulking while surrounding the bearing unit.

5. An assembly method of a bearing unit for mounting a rotary body to an engine cover, comprising:
force-fitting a housing of the bearing unit into the engine cover;
fitting a rotary body or a bracket of the rotary body over a rotating shaft of the bearing unit while the rotating shaft of the bearing unit is supported by a shaft jig through a counter bore; and
sealing the counter bore.
